(19) United States
(12) Patent Application Publication
(10) Pub. No.: US 2005/0012597 A1
(43) Pub. Date: Jan. 20, 2005

(54) Wireless electromagnetic tracking system using a nonlinear passive transponder

(76) Inventor: Peter Traneus Anderson, Andover, MA (US)

Correspondence Address: MCANDREWS HELD & MALLOY, LTD, 500 WEST MADISON STREET, SUITE 3400, CHICAGO, IL, 60661, US

(21) Appl. No.: 10/612,569

(22) Filed: Jul. 2, 2003

(51) Int. Cl. H04Q 5/22

(52) U.S. Cl. 340/10.4; 340/10.34

(57) ABSTRACT

A wireless electromagnetic tracking system using a nonlinear passive transponder is provided. The transponder employs a coil connected in parallel with a diode. The transponder emits a response signal when an excitation signal is incident upon the coil of the transponder. Inclusion of the diode in the transponder circuit introduces nonlinear characteristics into the waveform of the response signal emitted by the transponder. The nonlinear characteristics can be varied by changing the capacitance level of the transponder circuit. The nonlinear characteristics of the response signal can be used to discern the response signal from the excitation signal when both signals are received at a receiver. The nonlinear characteristics can also be utilized in a system of encoding data that is to be transmitted from a transponder to a receiver.

### CROSS-REFERENCE TO RELATED APPLICATIONS

Not applicable.

### STATEMENT REGARDING FEDERALLY SPONSORED RESEARCH OR DEVELOPMENT

Not Applicable.

### REFERENCE TO MATERIALS ON COMPACT DISC

Not Applicable.

### BACKGROUND OF THE INVENTION

The present invention generally relates to an electromagnetic tracking system. More particularly, the present invention relates to an electromagnetic tracking system accommodating a transponder that emits a signal where a portion of the emitted signal contains an additional frequency not found in the excitation signal.

Many medical procedures involve a medical instrument, such as a drill, a catheter, scalpel, scope, shunt or other tool. In some cases, a medical imaging or video system may be used to provide positioning information for the instrument. However, medical practitioners often do not have the use of such medical imaging systems when performing medical procedures. For example, the use of medical imaging systems for instrument tracking may be limited for health and safety reasons (e.g., radiation dosage concerns), financial limitations, physical space restrictions, and other concerns.

To compensate for limitations on the use of medical imaging systems, tracking systems that require only limited use of a medical imaging system may be employed. For example, a tracking system that provides position information of the medical instrument with respect to the patient or a reference coordinate system may be used. In such a system, an x-ray of an immobilized patient may be taken and a coordinate system may then be overlaid onto the x-ray image. The resulting x-ray and coordinate system may then be used to provide a map of the patient's anatomy. Subsequently, a medical practitioner may use the tracking system to ascertain the position of a medical instrument with respect to the coordinate system overlaid onto the x-ray image when the medical instrument is not within the practitioner's line of sight.

The tracking system allows the medical practitioner to visualize the patient's anatomy and track the position and orientation of the instrument. The tracking system may be used to determine when the instrument is positioned in a desired location and allow the medical practitioner to locate and operate on a desired or injured area while avoiding other structures. The tracking system may also be used to verify that the instruments have been removed from the patient at the end of a medical procedure. Increased precision in locating medical instruments within a patient provides for a less invasive medical procedure by facilitating improved control over smaller instruments with less impact on the patient. Improved control and precision with smaller instruments may also reduce risks associated with more invasive procedures like open surgery.

Tracking systems may also be used to track the position of items other than medical instruments in a variety of applications. For example, tracking technology may be used in forensic or security applications. Retail stores use tracking technology to prevent theft of merchandise. In such cases, a passive transponder is located on the merchandise and a transmitter is strategically located within the retail facility. The transmitter emits an excitation signal at a frequency that is designed to produce a response from a transponder. When merchandise carrying a transponder is located within the transmission range of the transmitter, the transponder produces a response signal that is picked up by a receiver. The receiver then determines the location of the transponder based upon characteristics of the response signal.

Tracking systems are similarly used in virtual reality systems or simulators. A transponder or transponders are located on a person or object. A transmitter emits an excitation signal and a transponder produces a response signal. The response signal is picked up by a receiver. The signal emitted by the transponder can then be used to monitor the position of a person or object in a simulated environment.

Some existing electromagnetic tracking systems have a transmitter and receiver wired to a common device or box. In systems with the transmitter and receiver wired to a common device, the object being tracked is wired to the same device as the components performing the tracking. Thus, the range of motion of the object being tracked is limited.

Wireless electromagnetic tracking systems allow for the object being tracked to be moved freely without being limited by connections with the transmitter or receiver. To reduce the bulk associated with attaching a battery or other power source to a transponder, passive transponders may employ a coil as a means of coupling with and receiving power from other devices.

Typically, a transponder is located on or within a device in order to track its movement. In order to determine the transponder's location, a transmitter generates an excitation signal that is incident on the transponder. The incidence of the excitation signal on the transponder causes the transponder to emit a response signal. In systems with passive transponders, the response signal is typically emitted at the same frequency as the excitation signal.

The response signal emitted by the transponder and the excitation signal emitted by the transmitter are incident upon a receiving coil. Typically, in a tracking system using a passive transponder the excitation signal is much larger than the response signal when both signals are received at the receiver. Because the response signal is emitted at the same frequency as the excitation signal and the response signal is much smaller than the excitation signal, it is difficult to accurately separate and measure the response signal.

Thus, a tracking system that improves separation and measurement of the response signal would be highly desirable. Additionally, an improved tracking system that may transmit data from a transponder to a receiver would be highly desirable.

### BRIEF SUMMARY OF THE INVENTION

A preferred embodiment of the present invention provides a wireless electromagnetic tracking system using a nonlinear passive transponder. The transponder employs a coil connected in parallel with a nonlinear device. The transponder emits a response signal when an excitation signal is incident upon the coil of the transponder. Inclusion of the nonlinear device in the transponder circuit introduces nonlinear characteristics into the waveform of the response signal emitted by the transponder. Characteristics of the nonlinear waveform may be varied by changing the capacitance level of the transponder circuit. The nonlinear characteristics of the response signal may be used to discern the response signal from the excitation signal when both signals are received at a receiver. The nonlinear characteristics may also be utilized in a system of encoding data that is to be transmitted from a transponder to a receiver.

### BRIEF DESCRIPTION OF THE DRAWINGS

FIG. 1 illustrates a nonlinear passive transponder in accordance with an embodiment of the present invention.

FIG. 2 is a circuit diagram of the nonlinear passive transponder illustrated in FIG. 1 in accordance with an embodiment of the present invention.

FIG. 3 illustrates a nonlinear passive transponder in accordance with an embodiment of the present invention.

FIG. 4 is a circuit diagram of the nonlinear passive transponder illustrated in FIG. 3 in accordance with an embodiment of the present invention.

FIG. 5 is a circuit diagram of the nonlinear passive transponder in accordance with an embodiment of the present invention.

FIG. 6 is a circuit diagram of the nonlinear passive transponder in accordance with an embodiment of the present invention.

### DETAILED DESCRIPTION OF THE INVENTION

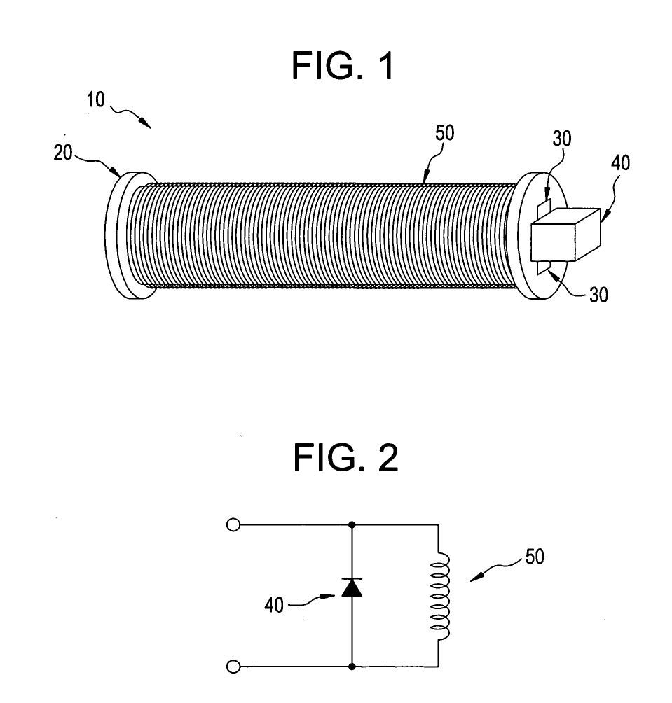

FIG. 1 illustrates a nonlinear passive transponder 10 in accordance with an embodiment of the present invention. The transponder 10 includes a core 20, the terminals 30, a diode 40, and a coil 50. The coil 50 is wound around the core 20. The core 20 has flanges on both ends to contain the build-up of the wire turns of coil 50. The two ends of the wire of coil 50 are connected to two terminals 30 that are attached to one of the flanges of core 20. The diode 40 is connected across the two terminals 30. In an embodiment, the diode 40 is connected in parallel with the coil 50 as depicted in the circuit diagram of FIG. 2.

In operation, the transponder 10 may be utilized in a tracking system (not shown). In a tracking system, a transmitter emits an excitation signal. The excitation signal may be one of various types of signals such as amplitude modulated, frequency modulated, phase modulated or continuous wave. The excitation signal emitted by the transmitter induces a signal in the coil 50 of transponder 10. In response to the excitation signal emitted by the transmitter, the transponder 10 emits a response signal.

Without the diode 40 connected to the transponder 10, the response signal emitted by the transponder 10 would be emitted at the same frequency as the excitation signal emitted by the transmitter. With the diode 40 connected to the transponder 10 as illustrated in FIGS. 1 and 2, the diode 40 introduces nonlinear characteristics into the transponder depicted in FIGS. 1 and 2. Because of the nonlinear characteristics of the diode 40, a portion of the response signal emitted by the transponder 10 contains an additional frequency or frequencies not found in the excitation signal emitted by the transmitter.

The additional frequencies contained in the portion of the response signal allow a receiver that is receiving signals from both a transmitter and transponder 10 to more easily distinguish between the excitation signal emitted by the transmitter and the response signal emitted by the transponder 10. Once the receiver has identified the response signal, the characteristics of the response signal may be used to calculate the position, orientation, and gain of the transponder.

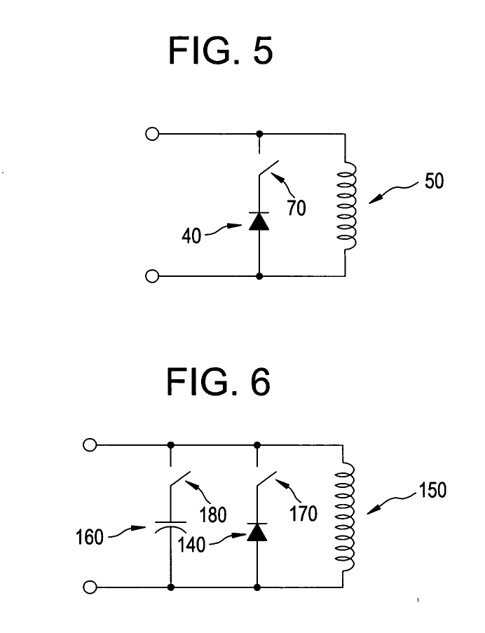

The additional frequencies contained in the portion of the response signal emitted by the transponder 10 can also be used to transmit data to a receiver. By connecting a controller to the transponder 10, characteristics of the response signal emitted by the transponder 10 may be controlled. For example, the controller may electrically connect and disconnect the diode 40 from the transponder 10 by opening and closing a switch 70 as depicted in FIG. 5. Connecting and disconnecting the diode 40 from the transponder 10 by operating a switch 70 alters the waveform of the response signal emitted by the transponder 10.

Values may be assigned to various states of the response signal that result when components are switched in and out of the transponder circuit 10. The values assigned to the various states may also depend upon the duration of time the response signal remains in a given state. The values assigned to the various states may be used in a system for encoding data that is intended to be transmitted from the transponder 10 to a receiver. For example, the state of the response signal when the diode is switched in the transponder circuit 10 may represent a “1” or “on” and the state of the response signal when the diode is switched out of the transponder circuit may represent a “0” or “off”. Thus, data may be transmitted by switching the diode in and out of the transponder circuit 10 and varying the response signal.

The receiver may be connected to a system that detects and identifies fluctuations in the response signal emitted by the transponder 10. Using the values assigned to the various states of the response signal, the system at the receiver end may translate the variations in the response signal into data such as the 1's and 0's mentioned previously.

In an alternative embodiment, nonlinearity may be introduced into the response signal by replacing the diode 40 or both the diode 40 and switch 70 with another type of nonlinear device such as a transistor or a synchronous rectifier. The device may then be used to track particular items and transmit code similar to the embodiment depicted in FIGS. 1, 2 and 5.

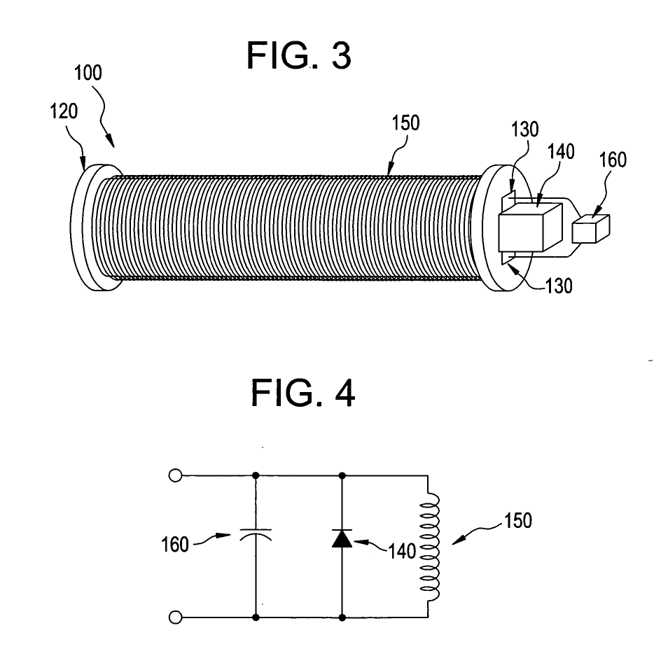

FIG. 3 illustrates a nonlinear passive transponder 100 in accordance with an embodiment of the present invention. The transponder 100 includes a core 120, the terminals 130, a diode 140, a coil 150, and a capacitor 160. The coil 150 is wound around a core 120. The core 120 has flanges on both ends to contain the build-up of the wire turns of coil 150. The two ends of the wire of coil 150 are connected to two terminals 130 that are attached to one of the flanges of core 120. A diode 140 is connected across the two terminals 130. A capacitor 160 is also connected across the two terminals 160. In an embodiment, the diode 140, the capacitor 160 and the coil 150 are connected in parallel as depicted in the circuit diagram of FIG. 4.

In operation, the transponder 100 is similar in operation to the transponder 10 of FIG. 1. That is, the transponder 100 may be utilized in a tracking system (not shown). An excitation signal emitted by a transmitter induces a signal in the coil 150 of transponder 100. In response to the excitation signal emitted by the transmitter, the transponder 100 emits a response signal.

Without the diode 140 connected to the transponder 100, the response signal emitted by the transponder 100 is emitted at the same frequency as the excitation signal emitted by the transmitter. With the diode 140 connected to the transponder 100 as illustrated in FIGS. 3 and 4, the diode 140 introduces nonlinear characteristics into the transponder 100 depicted in FIGS. 3 and 4. Because of the nonlinear characteristics of the diode 140, a portion of the response signal emitted by the transponder 100 contains an additional frequency or frequencies not found in the excitation signal emitted by the transmitter.

The additional frequencies contained in a portion of the response signal allow a receiver that is receiving signals from both a transmitter and transponder 100 to more easily distinguish between the excitation signal emitted by the transmitter and the response signal emitted by the transponder 100. Once the receiver has identified the response signal, characteristics of the response signal may be used to calculate a position, orientation, and gain of the transponder.

The additional frequencies contained in a portion of the response signal emitted by the transponder 100 may also be used to transmit data to a receiver. By connecting a controller to the transponder 100, characteristics of the response signal emitted by the transponder 100 may be controlled. For example, the controller may electrically connect and disconnect the diode 140 or the capacitor 160 from the transponder 100 by opening and closing switches 170, 180 as depicted in FIG. 6. Connecting and disconnecting the diode 140 or the capacitor 160 from the transponder 100 by operating switches 170, 180 may alter the waveform of the response signal emitted by the transponder 100.

Varying the level of capacitance of the capacitor 160 modifies characteristics of the additional frequencies present in a portion of the response signal emitted by the transponder 100. For example, voltage and current values at various harmonic levels for a given transponder configuration will vary as the capacitance of the capacitor 160 is varied. These changes in harmonic levels and other waveform characteristics can be used to distinguish between various transponders 100 having a capacitor 160 with different levels of capacitance attached to them. Being able to distinguish one transponder from another transponder may then allow a tracking system to track and identify the different devices to which the transponders are attached.

Values may be assigned to the various states of the response signal that result when components are switched in and out of the transponder circuit 100. The values assigned to the various states may also depend upon the duration of time the response signal remains in a given state. The values assigned to the various states may be used in a system for encoding data that is intended to be transmitted from the transponder 100 to a receiver. For example, the state of the response signal when the diode 140 is switched in the transponder circuit 100 may represent a “1” or “on” and the state of the response signal when the diode 140 is switched out of the transponder circuit may represent “0” or “off”. Additionally, states of the response signal when the capacitor 160 is switched in or out, alone or in combination with switching of the diode 140, may represent assigned values such as “0”, “1”, “2”, “3”, etc. Thus, data may be transmitted by switching the diode 140 and/or capacitor 160 out of the transponder circuit 100 and varying the response signal.

The receiver may be connected to a system that detects and identifies fluctuations in the response signal emitted by the transponder 100. Thus, electrically switching the diode 140 or the capacitor 160 in and out of the transponder circuit 100 may be used to transmit encoded data from a transponder 100 to a receiver. Using the values assigned to the various states of the response signal, the system at the receiver end can translate variations in the response signal into data such as the 1's and 0's mentioned previously.

In an alternative embodiment, nonlinearity may be introduced into the response signal by replacing the diode 140 or both the diode 140 and switch 180 with another type of nonlinear device such as a transistor or a synchronous rectifier. The device may then be used to track particular items and transmit code similar to the embodiment depicted in FIGS. 3, 4 and 6.

While the invention has been described with reference to certain embodiments, it will be understood by those skilled in the art that various changes may be made and equivalents may be substituted without departing from the scope of the invention. For example, the diode 40, 140 may be replaced with another type of switching or nonlinear device such as a transistor or a synchronous rectifier for introducing nonlinearity into the response signal. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A transponder in a wireless electromagnetic tracking system, said transponder including:
a coil for transmitting a signal in a wireless electromagnetic tracking system; and
a rectifying device connected in parallel with said coil.

2. The transponder of claim 1 wherein said rectifying device is a diode.

3. The transponder of claim 1 further including a capacitor connected in parallel with said coil.

4. The transponder of claim 1 further including a switch connected in series with said rectifying device.

5. The transponder of claim 3 further including a switch connected in series with said rectifying device or said capacitor.

6. The transponder of claim 4 further including a controller for controlling the operation of said switch.

7. The transponder of claim 5 further including a controller for controlling the operation of said switch.

8. A method for tracking a transponder in a wireless electromagnetic tracking system comprising:
receiving a first signal at a coil in a transponder in a wireless electromagnetic tracking system; and
rectifying said first signal with a diode connected in parallel with said coil.

9. The method of claim 8 further including the step of transmitting a second signal from said coil.

10. The method of claim 8 further including varying the capacitance of said transponder with a capacitor connected in parallel with said coil.

11. The method of claim 10 further including the step of operating a switch connected in series with said diode or said capacitor.

12. The method of claim 11 further including controlling the operation of said switch with a controller.

13. A transponder in a wireless electromagnetic tracking system, said transponder consisting of:
a core for transmitting a signal in a wireless electromagnetic tracking system;
a coil wrapped around said core; and
a diode connected to said coil.

14. The transponder of claim 13 further consisting of a capacitor connected to said coil.

15. A method for tracking a transponder in a wireless electromagnetic tracking system comprising:
receiving a first signal at a transponder in a wireless electromagnetic tracking system, wherein said first signal is received at a first frequency;
transmitting a second signal from said transponder, wherein said second signal contains a second frequency.

16. The method of claim 15 further comprising the step of rectifying said first signal with a diode.

17. The method of claim 15 further comprising the step of rectifying said first signal with only one diode.

18. The method of claim 15 further comprising the step of identifying said transponder based upon said second frequency.

19. The method of claim 15 further comprising the step of varying the capacitance of said transponder, wherein said change in capacitance changes said second frequency.

20. The method of claim 19 further comprising the step of identifying said transponder based upon said second frequency.

21. A method for transmitting data in a wireless electromagnetic tracking system comprising:
transmitting a signal from a transponder in a wireless electromagnetic tracking system, wherein said signal contains at least a first frequency and a second frequency,
varying at least said second frequency to produce a variation in at least said second frequency; and
encoding data in said signal based upon said variation in at least said second frequency.

22. A method for tracking a transponder in a wireless electromagnetic tracking system comprising:
receiving a first signal at a transponder in a wireless electromagnetic tracking system, wherein said first signal is received at a first frequency;
transmitting a second signal from said transponder, wherein said second signal includes said first frequency and a second frequency.

23. The method of claim 22 further comprising the step of rectifying said first signal with a diode.

24. The method of claim 22 further comprising the step of rectifying said first signal with only one diode.

25. The method of claim 22 further comprising the step of identifying said transponder based upon said second frequency.

26. The method of claim 22 further comprising the step of varying the capacitance of said transponder, wherein said change in capacitance changes said second frequency.

27. The method of claim 26 further comprising the step of identifying said transponder based upon said second frequency.

28. A transponder in a wireless electromagnetic tracking system, said transponder including:
a coil for transmitting a signal in a wireless electromagnetic tracking system; and
a switching device connected in parallel with said coil.

29. The transponder of claim 28 wherein said switching device is a switching diode.

30. The transponder of claim 28 wherein said switching device is a synchronous rectifier.

31. The transponder of claim 28 wherein said switching device is a transistor.

32. The transponder of claim 28 further including a capacitor connected in parallel with said coil.

33. The transponder of claim 32 further including a switch connected in series with said capacitor.

34. The transponder of claim 33 further including a controller for controlling the operation of said switch.
